(19) United States
(12) Patent Application Publication
(10) Pub. No.: US 2025/0378512 A1
(43) Pub. Date: Dec. 11, 2025

(54) Process, System and Method for Automated Property Transformation in Community Association Delinquent Unit Owner Claims Recovery

(71) Applicant: Chetannlee, LLC, Boca Raton, FL (US)

(72) Inventors: Leigh C. Katzman, Fort Lauderdale, FL (US); Mary Ann Chandler, Fort Lauderdale, FL (US); Ferren L. Korr, Boca Raton, FL (US)

(73) Assignee: Chetannlee, LLC, Boca Raton, FL (US)

(21) Appl. No.: 19/232,502

(22) Filed: Jun. 9, 2025

Related U.S. Application Data
(60) Provisional application No. 63/657,184, filed on Jun. 7, 2024.

(51) Int. Cl. G06Q 50/16; G06Q 50/163

(52) U.S. Cl. CPC G06Q 50/165; G06Q 50/163

(57) ABSTRACT

A system and method for community associations to recover delinquent assessments by assigning rights to a third party, who automates property transformation. The system receives delinquency data, executes legal title transfer via foreclosure, and applies a standardized rehabilitation process using automated inspection and repair protocols to prepare units for new occupants, generating revenue while ensuring association financial stability

### BACKGROUND OF THE INVENTION

This invention relates to a process for a community association to obtain possession of a living unit after its previous occupant was delinquent in paying assessments, preparing the living unit for a new occupant, and then obtaining payments from the new occupant.

Condominium, Cooperative and Homeowners Associations (hereafter, collectively, “Associations”) are the three prevalent forms of community living throughout the US. While the Associations share similarities in their aim to manage and maintain communal living spaces, they differ in their legal structure, ownership rights, and governance.

All three types of Associations are based on the concept of living in a shared community, where members have access to common facilities and areas. All three types of associations operate under a set of Governing Documents, which include Declarations, Covenants, Conditions, and Restrictions (CC&Rs), Articles of Incorporation, Bylaws and Rules and Regulations that outline the rights and obligations of both the Associations and their members.

Members of condominiums, cooperatives, and Homeowners Associations are required to pay maintenance fees/assessments (hereafter, “Assessments”). These Assessments cover the expenses of operating and maintaining the Association, including at least the costs of maintenance of the common elements/areas, amenities, as well as other costs such as management, employees, insurance, accountants and attorneys-all as set forth in the annual operating budget.

Each Association is managed by a volunteer board of directors elected by and from the members. The board is responsible for enforcing the Governing Documents, managing the community's finances, and making decisions regarding the maintenance, operation and administration of the community.

### Condominiums (Condos)

In a condominium building, individuals own their specific unit (the boundaries of which are contained in the Declaration), along with an undivided share of the total common areas and facilities. A condominium is governed by a condominium association, which specifically deals with the maintenance, operation and management of the condominium buildings and common areas.

### Cooperatives (Co-Ops)

In a cooperative building, individuals do not own their units. Instead, they own shares in a corporation that owns the property. Their occupancy rights are typically governed by a proprietary lease or occupancy agreement. A cooperative is managed by a cooperative association, which is similar to a condominium association, but operates under the principles of cooperative ownership.

### Homeowners Associations (HOAs)

In communities governed by an HOA, individuals own their homes and the land upon which it sits. This can include single-family homes, townhouses, or duplexes, depending on the community. An HOA governs these communities, focusing on the broader community that May include private streets, parks, and other amenities.

Each owner in an Association (hereafter, “Owner”) has an affirmative obligation to pay the portion of the Association's annual common expenses that are attributable to his or her ownership interest in the Association: his or her Assessments. Much like a potluck dinner where everyone contributes a dish to create a satisfying meal for all attendees, community Association Assessments are contributions made by residents to ensure the smooth functioning and maintenance of shared amenities and services. When individuals neglect, refuse or are unable to pay their Assessments, it creates a burden on the rest of the community members who are fulfilling their obligations.

While the financial success and economic viability of a community Association depends on the timely payment of Assessments by the Owners, the reality is that nearly every Association has some percentage of its membership that is delinquent in the payment of budgeted maintenance Assessments at any given time. The higher the delinquency rate the more difficult it is for the Association to meet its budgeted expenses, and the more time, effort and resources the board and manager must expend in their unintended role as debt collectors.

An Association's Assessment stream is the lifeblood that funds essential community services like insurance, utilities, accounting and legal as well as amenities such as recreational facilities and security. Associations that are not fully funded are forced to cut corners which can result in the inability to provide essential services and may expose the Association to potential liability.

Therefore, when Owners do not pay these Assessments, the Association's board of directors has an affirmative duty and fiduciary obligation to pursue owners for delinquent Assessments and other charges owed to the Association through the collection process, which includes lien and foreclosure.

Unfortunately, the collection of delinquent accounts in and of itself requires the Association to incur legal expenses, which, depending upon the number of delinquent accounts, may exceed the estimated legal expenses in the Association's annual budget. Legal fees and costs of collection, together with “bad debt” incurred from the inability to collect delinquent amounts results in an additional burden being placed on the paying members of the community to shoulder the financial weight of their non-paying neighbors. Unfortunately, this often results in the Association's need to increase Assessments, which in turn, has the unintended consequence of further increasing delinquency rates and detrimentally impacting the Association's and individual owners' financial health.

Rather than maximizing shareholder returns, not-for-profit corporations such as Associations are dedicated to advancing the well-being of the community and its members. Financial certainty in Associations is paramount because it directly impacts their ability to fulfill their missions and deliver essential services to the membership.

One key reason why financial certainty holds heightened importance in Associations is the nature of their funding sources. Unlike for-profit businesses that generate revenue primarily through sales and investments, Associations rely solely upon Assessments paid by each member for its funding. These funding streams can be unpredictable and subject to fluctuations influenced by economic conditions and individual personal finances.

Consequently, financial uncertainty in an Association can jeopardize its ability to provide for all budgeted services and perform preventative and necessary maintenance. For example, a sudden increase in Assessment delinquencies could force an Association to scale back its services, ignore required repairs and maintenance, or even in extreme cases cease operations altogether, directly impacting the community it serves.

Moreover, the fiduciary responsibilities of Association board members and leadership demand a heightened focus on financial certainty. Board members of residential not-for-profit organizations are entrusted with safeguarding the organization's assets and ensuring they are used effectively to advance its mission. In times of financial instability, board members face the challenge of making difficult decisions to steer the organization back to solid ground while staying true to its purpose and obligations to stakeholders.

### SUMMARY OF THE INVENTION

Disclosed herein is a unique process relating to Community Association law and the way Condominium, Cooperative and Homeowners Associations handle their budgeting and finances. The process disclosed herein is referred to as the Association Subrogation Optimization Process (hereinafter, “ASOP”), and is a unique process that may be used by assignees Lenders, Insurers and Law Firms (hereafter, collectively, “Users”) to help Associations avoid the above-referenced instability and a potential debt spiral, and reduce or eliminate their delinquencies. ASOP generates significant Return on Investment (ROI) for the Lenders, Insurers and Law Firms providing ASOP-backed services to Associations, thereby presenting an incentive for the Users to provide the ASOP process at no cost to the Associations.

For the Association these ASOP-backed services preserve real estate values, reduce uncertainty, volatility, and stress for hundreds of thousands of volunteer board members running Associations throughout the U.S.

Disclosed herein is a process for generating revenue streams for Users while also reducing or eliminating Owner delinquencies and providing Associations with financial stability and, in many cases, fully funded annual budgets.

ASOP-backed services, when provided by Lenders, Insurers, Law Firms, and others, generate and create additional revenue streams over and above market standard interest, premiums, and fees, respectively as explained more fully immediately below.

In addition to loan interest and other revenue incident to the lending process, Lenders that loan to Associations can expect more secure loans by use of ASOP. In addition, Insurance companies that provide budget insurance to Associations can expect a lower loss ratio values by use of ASOP. In addition, law firms that provide legal collection services to Associations can expect an increased client base by use of ASOP.

One of the reasons the ASOP method is so effective is due to state statutes and restrictive covenants that run with the land. Such statutes and covenants grant Associations substantial rights and powers over the units within a complex of multifamily homes and individual homes situated within the building(s) or community. As a condition of every loan and/or policy issued and/or retainer signed, User obtains an Assignment of Rights (hereafter AOR) from the Association. The AOR includes, along with other powers, collection, lien and foreclosure rights. This means that whenever an individual unit in the Association becomes delinquent in assessment and/or maintenance payments, User “steps into the shoes” (i.e., takes the legal place, like a delegate or deputy) of the Association to collect the delinquent account, without charge, to the Association, and as a consequence obtains for itself the financial benefits described below.

The rights typically granted to User by the AOR include: (1) the right to charge interest on the unpaid assessment at the highest rate permitted by law; (2) the right to charge late fees per installment, if provided in the Association's governing documents; (3) the right to record and foreclose a claim of lien upon the secured real property seeking full payment of all past due Assessments, interest, late fees, costs of collection and reasonable attorney's fees and attorney's costs incurred in the collection process irrespective of superior and inferior lienholders and/or homestead exemptions; (4) the right to obtain a personal judgment against the delinquent owner(s) for nonpayment of all above amounts due; and (5) the right to name and foreclose the interests of any other lien holders inferior to the Association's lien and extinguish those inferior interests through the collection, lien and foreclosure process.

### BRIEF DESCRIPTION OF THE DRAWINGS

FIG. 1 is a first portion of a flow chart illustrating steps in the present invention.

FIG. 2 is a second portion of a flow chart illustrating steps in the present invention.

FIG. 3 is a third and final portion of a flow chart illustrating steps in the present invention.

In describing the preferred embodiment of the invention which is illustrated in the drawings, specific terminology will be resorted to for the sake of clarity. However, it is not intended that the invention be limited to the specific term so selected and it is to be understood that each specific term includes all technical equivalents which operate in a similar manner to accomplish a similar purpose. For example, the word connected or terms similar thereto are often used. They are not limited to direct connection, but include connection through other elements where such connection is recognized as being equivalent by those skilled in the art.

### DETAILED DESCRIPTION OF THE INVENTION

Patent application Ser. No. 63/657,184, which is the priority application, is incorporated in this application by reference.

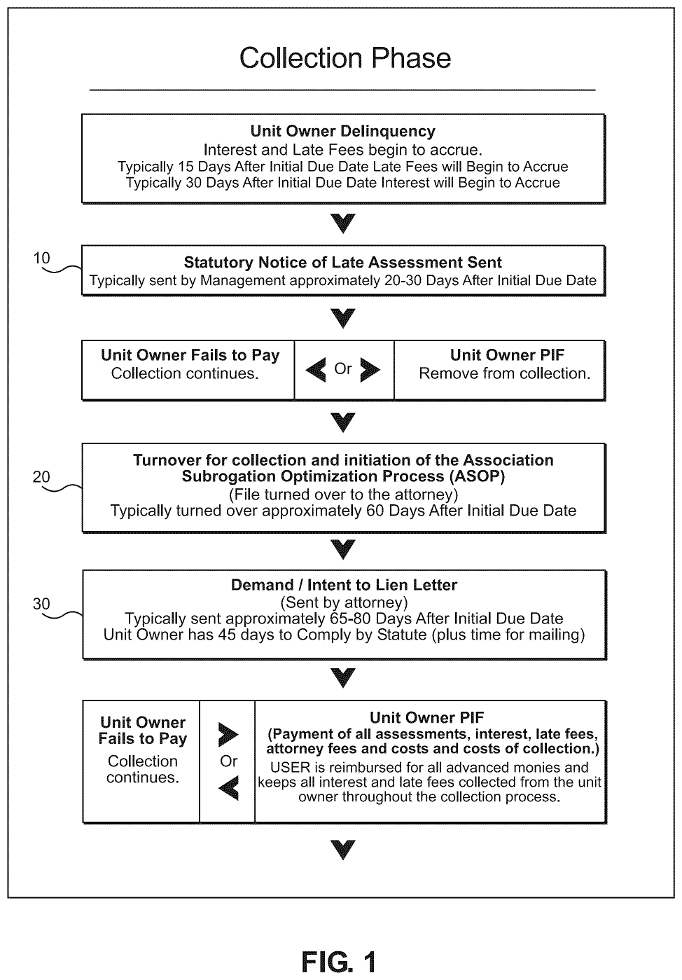

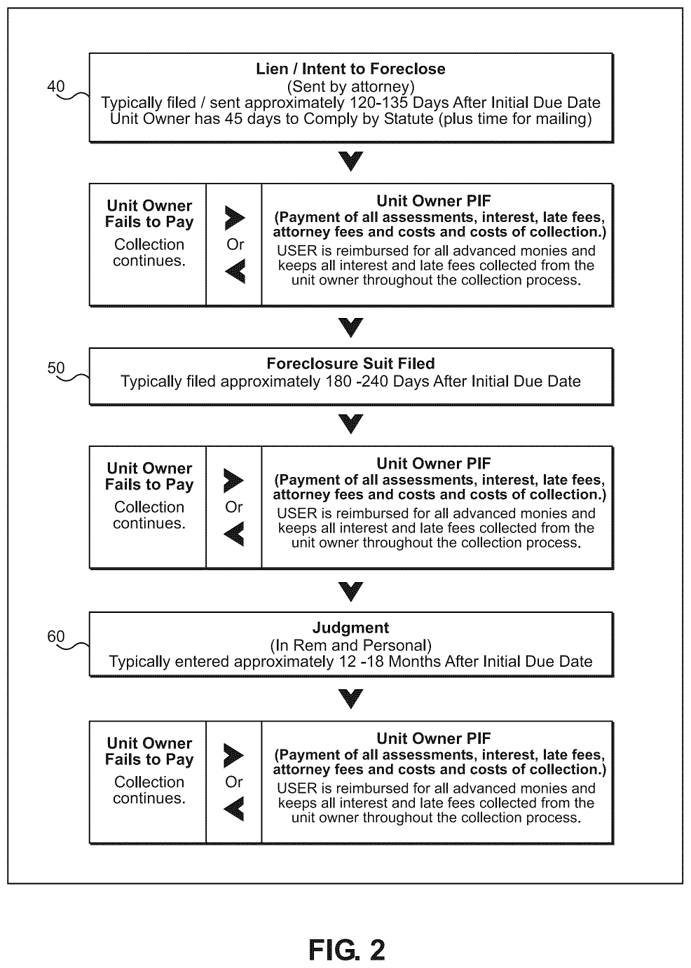

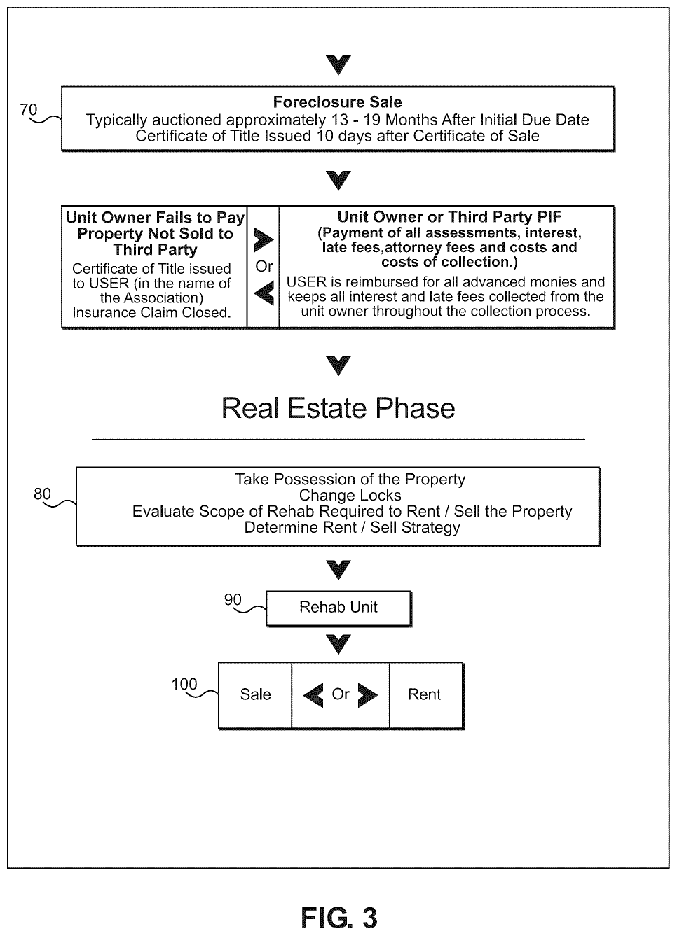

When pursuing owners for delinquent Assessments, in addition to any requirements contained in the Association's Governing Documents or properly adopted collection policy, strict statutory guidelines apply to how the Association, or its delegates/deputies, must proceed. The most important of these statutory guidelines deals with notice requirements. If the Owner pays in full (PIF) all amounts due in response to one or more of the following notices, the collection process ends. The process required is illustrated in flow chart form in FIGS. 1-3, which are sequential. The phase subsequent to the collection phase relates to making the real estate unit available for rent or sale, and is discussed below after discussion of the collection phase.

For example in Florida, when an owner falls delinquent in the payment of Assessments or other charges, the Association must issue a statutory Notice of Late Assessment 10 prior to turning the matter over to legal (typically a Law Firm) for commencement of collection. The notice requirement for the Notice of Late Assessment is thirty (30) days. If the Owner fails, or refuses, to pay all amounts due pursuant to the notice within the statutory timeframe, the account may be turned over to a lawyer 20 to initiate the collections phase.

The Demand/Intent to Lien Letter 30 is generally a Law Firm's initial communication with the delinquent owner regarding amounts owed to the Association, and is intended to notify the delinquent owner of the Association's intent to place a lien on the property if the delinquent amounts are not brought current. The notice requirement for the Demand/Intent to Lien Letter is forty-five (45) days.

If the delinquency is not cured pursuant to the Demand/Intent to Lien Letter, a Claim of Lien may be recorded against the property. A Claim of Lien is a document recorded in the public records of the county in which the property is located. This claim secures past due and future Assessments, interest (in the amount provided in the governing documents or, if no amount is provided, then at the highest rate permitted by law, which may be eighteen (18%) percent per annum), late charges, costs of collection, reasonable attorney's fees and attorney's costs, less credit for any partial payments made.

The owner is then notified of the recorded lien, as well as the Association's intent to foreclose such lien, in an Intent to Foreclose Letter 40. This final notice requirement may be identical to the notice requirement for the Demand/Intent to Lien Letter at forty-five (45) days.

If the delinquent owner fails to pay the outstanding balance within the specified timeframe contained in the Intent to Foreclose Letter 40, the Association has an affirmative duty in nearly all circumstances to initiate foreclosure proceedings to foreclose upon the lien with the filing of a Lis Pendens and Complaint 50. Foreclosure is a legal process by which the Association seeks to sell the delinquent owner's property at a public auction to satisfy the unpaid Assessments.

If the delinquent owner fails to pay the outstanding amounts due prior to the issuance of a Final Judgment of Foreclosure 60 by a Court, the property will be sold at a public auction 70. The proceeds from the sale are used to fully satisfy the Association's lien. Any surplus funds remaining after the lien is satisfied may be returned to the former owner, or a creditor of the former owner, depending on state law. In the event that there are no third-party bidders at the foreclosure auction, or if no third party bids up to or more than the judgment amount, a Certificate of Title will issue in the name of the Association (which is automatically authorized by law to bid up to the judgment amount without additional cash deposit to the clerk's office), and the Association, or its designated User, may take possession 80.

Costs of collection as well as attorneys' fees and attorney's costs incurred in the collection process are the financial responsibility of the delinquent owner, and are due in addition to principal owed, interest and late fees. Any and all partial payments received are applied in accordance with the statutory application of payments—in Florida, first to interest and late fees, then to attorneys' fees and costs, and last to the delinquent Assessment amounts.

Throughout the entire collection and foreclosure process numerous opportunities to collect rents, manage properties and acquire residential units present themselves. Further, in certain situations, at the conclusion of the collection and foreclosure process, User (by virtue of the AOR) will obtain title to units in the name of the Association. This would permit the User to rent the unit. The collection of rent is a financial incentive to the User and the Association to lease and manage a unit that would otherwise stand empty.

In markets where values are high and there is substantial equity in units, first mortgage holders who are also not being paid would most likely follow quickly with their own foreclosure. This makes renting the unit, by the Association or anyone it hires to manage rental of foreclosed units, an exercise in futility.

However, in less favorable housing markets where values are lower and substantial equity does not exist, first mortgage holders tend to delay their own foreclosure(s). This opens the opportunity for User to rent out units for many months or even years before the first mortgage holder forecloses.

Economies of scale allow User to operate a profitable rental model whereby minor repairs and rehabilitation 90 of units can be made quickly and inexpensively. Some of these typical upgrades to ready the unit for rental can be reused multiple times and transferred quickly and efficiently from one unit to another within a portfolio of such units. For example, if foreclosure by the first mortgage holder is initiated, appliances and other personal property that are not deemed fixtures to the property may be moved from one unit to another.

It should be noted that under certain circumstances, User may be able to collect rents on units even before title has transferred. These rental opportunities can arise if the unit Owner abandons the unit, if the unit Owner dies, in the event of blanket/individual receivership, and after eviction. Foreclosure can be a long public event that is embarrassing and financially draining on homeowners. Therefore, some Owners decide to grant a deed in lieu of foreclosure, and this allows a quicker option where User agrees to take the unit instead of continuing the foreclosure process.

By virtue of the AOR, ASOP is provided with a variety of unique and exclusive opportunities to manage and/or acquire residential units, and this can occur before the units are available or offered for sale to the public. Contained within the governing documents for many Associations is the right for the Associations to screen and/or approve all proposed voluntary transfers of units within the building(s) and/or community. Further, some Associations have a Right of First Refusal (ROFR)—the first and exclusive opportunity to purchase the property upon the unit owner's decision to sell at the same terms offered by a third party. Not every Association's governing documents will provide a ROFR, but in those that do, any sale of any unit in the Association becomes a potential buying opportunity for User.

The ROFR is a right seldom exercised. The main reason for its limited use is that Associations are not-for-profit entities, and are therefore generally not looking for strategies to increase revenue. However, for USER, the ROFR presents a tremendous opportunity to obtain properties at the most competitive prices.

One of the most powerful rights covered by the AOR is the right to foreclose on a unit for non-payment. In the event the Owner does not or cannot make full payment on the debt at the conclusion of the collection and foreclosure process, the property will be sold at Foreclosure Sale/Public Auction. This represents another unique opportunity for USER (by virtue of the AOR) to acquire units, as described below, inasmuch as the Associations may secure the possession 80 of the property without any expenditure up to the amount due. In the event that there are no third-party bidders at the foreclosure auction, or if no third party bids up to or more than the judgment amount, a Certificate of Title will be issued in the name of the Association. The Association is automatically authorized by the law of some states to bid up to the judgment amount without additional deposit to the clerk's office. This permits the Association to “outbid” third parties without spending any additional money. This permits the Association to gain possession of the property and turn the property over to User, which can then carry out the ASOP, as described herein, to create benefit almost immediately for both User and Association.

At the Foreclosure Sale, by virtue of the AOR, User will have a distinct advantage over other bidders on the property. Unlike the other potential buyers, since User has stepped into the shoes of the Association, it may have had the opportunity to inspect the interior of the unit. No third party bidder has this potential opportunity, and the information User is able to acquire by inspecting the condition of the unit to determine the true market value gives it a significant edge against the other bidders in the auction process.

The acquisition methods (Quit Claim Deed, Deed in Lieu, ROFR, Receivership, Abandonment and Foreclosure Sale, etc.) provided by ASOP will often lead to classic fix/rent/flip scenarios whereby units are acquired, rehabilitated and then rented and/or sold. The advantages provided by ASOP puts USER at the forefront of acquiring and transforming distressed assets into profits for itself while helping the Association regain financial stability.

In some embodiments, an USER (Real Estate Division) will employ a unique Fix/Rent/Flip process whereby units are acquired, rehabbed and then rented and/or sold. The process starts before the unit is ever acquired, as outlined below.

### Rehab Step 1: Develop Detailed Scope of Work

By virtue of the AOR, User may have a distinct advantage over other bidders on, or potential buyers of, the property. Unlike the other potential buyers at public auction, User has “stepped into the shoes of” the Association. Thus, it will be intimately familiar with the property and its present condition. The information User is able to acquire by being able to inspect the condition of the property is used to assess what work must be done to bring the unit to a rentable condition. The scope of work and rehab plan can be formulated before the other potential buyers are even aware the property may become available for sale.

### Rehab Step 2: Execute Work

In one embodiment, the User vertically integrates the entire Real Estate Component so that the work on the property, which would typically fall to a General Contractor and Subcontractors, would be handled in-house. Economies of scale allow User to operate a profitable rental model whereby minor repairs and rehabs of units can be made quickly and inexpensively. Some of these typical upgrades to ready the unit for rental can be reused multiple times and transferred quickly and efficiently from one unit to another within the portfolio.

The similarities between the units within an Association allow User to formulate one rehab package template that will serve the needs of the vast majority of the units. Unlike purchasers of individual units who have to customize the scope of work on a one-off model, the assembly line process of handling the rehabs gives User an edge over other investors in distressed properties.

The model utilizes customized annual leases that allow for early termination in the event of foreclosure by a superior interest holder (such as a first mortgagee). Assuming there will always be several units coming in and out of the control of User at any given time, easy transport of tenants from one unit to another within the portfolio provides stability for the tenants and for User's generation of consistent rental income. As part of the vertical integration, User can cost effectively and profitably offer intra-community moving services for these tenants as well.

The transformation module automates property inspection and rehabilitation. Exterior inspection may employ a drone equipped with a high-resolution camera and environmental sensors, transmitting data via a secure network to a central server for real-time analysis. The data recovered assists in generating a rehabilitation plan, specifying tasks such as changing mechanical or electronic locks (e.g., reprogramming electronic codes), painting high-wear surfaces, and sanitizing units to comply with state regulations. Lock changes involve either replacing lockset components or updating electronic codes stored in a database, ensuring secure access control. These steps physically and legally transform the property, enabling rental to a new occupant.

Each rehab package template will be crafted to the unique circumstances of the underlying Association granting the AOR. For example, multi-million dollar luxury ocean front units have different rehab needs to attract a tenant than units that sell for under $200K.

### Example 1

As an example of how the process (ASOP) works, Unit 123 in Sample Condominium Association becomes delinquent in assessment payments. The owner of Unit 123 fails to pay despite collection efforts. Those collection efforts require due process set by law and/or contract, and must be followed. Once the due process is completed, as described above for Florida and outlined in the flow chart of FIGS. 1-3, a Foreclosure Judgment is entered and a Foreclosure sale date is set. User's real estate division inspects Unit 123 and prepares a scope of work that has been identified. In some embodiments, User has a team ready to address the work identified before any other potential investor has even had an opportunity to bid. Once the sale is conducted, if User has the highest bid, Certificate of Title is issued and Unit 123 is acquired. Because of the previous inspection, there is little delay to starting the rehab process and getting a paying tenant into the Unit, thereby resulting in the revenue stream to User and Assessments going forward to the Association.

Looking at the details of the real estate phase of the process, the User takes one or more of the steps in the typical rehab package template listed above upon taking possession of Unit 123. For example, the User (or a delegate) makes a physical inspection of Unit 123. The inspection required may be the same inspection that occurred prior to acquisition of the unit, but it is discussed here in detail. For inspection, a person must enter every room of Unit 123 to observe any abnormality that may require corrective action. It is contemplated that a User May use the service of a drone, robot or other human substitute that enters the property and uses a camera and possibly a communication link, such as internet, to permit remote inspection rather than in-person inspection. Nevertheless, physical entry to the unit and visual (and perhaps other senses, such as audible) inspection takes place, whether the human performing the inspection is in the unit or inspects via camera and other sensory tools mounted to the drone/robot. The steps of opening and closing the doors to enter and exit the unit change the unit, including allowing some of the air within the unit to mix with the air that is outside the unit, and vice versa. Movement around the unit also changes the unit, such as by contacting the floors when walking, and by moving items in the unit, such as the doors and windows.

Before, during or after inspection, another step may be carried out that outfits Unit 123 with new barriers to entry so that the User may control entry to the unit. This may include changing the locks, which includes the traditional, physical change of the locksets/deadbolts, or components thereof, to assign new physical keys to the unit. Alternatively, this may involve changing an electronic code for an electronic lockset, such as an electronic deadbolt. In this second example, nothing mechanical about the lock is changed, but the electronic data required to provide entry (e.g., 4-digit code) is changed so only those who know and enter the data into the lockset may enter the property.

Access to common elements and amenities through key cards, transponders or electronic codes are examples of additional physical and non-physical changes to the unit and access thereto.

In most or all cases, trash and any unwanted items of the previous occupant must be removed from the unit. For example, those who leave Unit 123 may leave paper boxes and/or furniture in Unit 123 after vacating the unit. This trash and furniture must be removed before another occupant may occupy the unit. Such a requirement may be by law, because some states require sanitation of a unit prior to renting to a tenant, or for the sake of goodwill.

In many cases the interior walls and/or ceiling of a unit may be painted, if necessary or desired. The flooring may also need to be cleaned, repaired or replaced. Painting and flooring replacement are common repairs to units prior to a new occupant moving in, because walls and floors are high wear surfaces. It is usually necessary or desirable to inspect the HVAC system and clean/repair if necessary. It is also necessary or desirable to inspect the appliances, if any, and repair or replace them if necessary. Finally, the unit will need to be sanitized, which includes, but is not limited to, the removal of any matter on surfaces that would commonly be considered to make the surface “dirty” or “unclean.” This includes food, food waste, human waste, dirt, grease, oil or any other matter that is commonly removed in order to enhance the sanitary nature or cleanliness of a property. The step of removing any of these materials is considered “sanitizing,” and the sanitization of the unit is a step that is often considered legally necessary prior to a new occupant taking possession of a property.

Typically, once a paying tenant has been placed in the unit, User only has to pay, insurance and minor upkeep. User has no obligation to pay any Association Assessments, mortgage payments, real estate taxes or any other encumbrances upon the property. Thus, rent paid by the tenant may be retained by the User.

In the above example, the process (ASOP) carried out is unique and beneficial to the Association and the User. The Association gets free collection work and is rid of a non-paying owner while the User receives rent. The steps taken in every instance are described here, but may be in a different order than that described. Other steps taken may not be named here, but those steps would be understood by a person familiar with the process of maintaining, rehabilitating and renting property.

The steps taken in the process include the due process step or steps mandated by law and/or contract prior to taking possession of the property. This typically includes notification to the occupant of the property that possession will be taken by the User, and transparent, public court action to involuntarily change title to the Association from the prior occupant. Once this due process is completed and Association possesses the property, the User or a delegate inspects the property. Of course, this inspection may take place prior to completion of all steps of the due process, but nevertheless, an inspection by entering the property occurs. Entry into the property changes the property from its prior condition, as noted above. Additional steps include changing the locks, which may be any of the optional steps described herein, such as mechanically modifying the locksets, or modern electronic equivalent. In every instance, the locks will be changed as described herein.

Once possession of the property is taken and all steps necessary for a new occupant have been taken, the unit may be occupied by the new occupant, and payments may be collected from him or her. The User risks losing some of his/her investment in the cleaning and repair of the property if a first mortgage holder (which has superior rights) forecloses on the property. Nevertheless, if the investment is small enough, or some of the investment may be recovered (e.g., new appliances may be removed from the property), then the payments received May exceed the investment in the property such that the investment is justified by the short term payout. Alternatively, the first mortgage holder may sell the property to the User, which can continue renting to the occupant. Alternatively, the occupant may be forced to move to another unit nearby that is equivalent or better than the occupied unit, but this has been accounted for in the lease agreement with the occupant. In this case, the occupant must vacate the property but he or she had an understanding that this may occur when he or she signed the lease agreement with User.

This detailed description in connection with the drawings is intended principally as a description of the presently preferred embodiments of the invention, and is not intended to represent the only form in which the present invention may be constructed or utilized. The description sets forth the designs, functions, means, and methods of implementing the invention in connection with the illustrated embodiments. It is to be understood, however, that the same or equivalent functions and features may be accomplished by different embodiments that are also intended to be encompassed within the spirit and scope of the invention and that various modifications may be adopted without departing from the invention or scope of the following claims.

1. An automated method for a community association to recover delinquent assessments, comprising:
(a) notifying the first occupant of the delinquency of the assessments and proceeding through foreclosure in the event of non-payment;
(b) a third party, under an assignment of rights from the community association, obtaining legal title of the property in the name of the community association via foreclosure;
(c) inspecting the property using an automated system, including a drone with sensors, to generate a rehabilitation plan;
(d) transforming the property by executing the rehabilitation plan, including changing at least one entry lock and sanitizing the property;
(e) leasing the property to a second occupant who pays a fee;
(f) the third party receives the fee in lieu of service costs; and
(g) the community association receiving a portion of the fee as assessments.”

2. The process in accordance with claim 1, wherein changing at least one entry lock comprises updating an electronic lock code stored in a secure database, synchronized with a central server for access control.

3. The process in accordance with claim 2, wherein the step of changing at least one entry lock to the property comprises physically removing at least a portion of a lock from an entry door and replacing the removed portion with a different portion.

4. The process in accordance with claim 2, wherein the step of changing at least one entry lock to the property comprises changing a code to a mechanical lock.

5. The process in accordance with claim 2, wherein the step of changing at least one entry lock to the property comprises changing a code to an electronic lock.

6. The process in accordance with claim 1, wherein inspecting the property comprises deploying a drone with a camera and environmental sensors to collect data, which is processed by a machine learning model to generate the rehabilitation plan.

7. The process in accordance with claim 1, wherein the step of preparing the property for use by a second occupant comprises sanitizing the property.

8. The process in accordance with claim 1, wherein the step of preparing the property for use by a second occupant comprises painting at least one surface of the property.

9. The process in accordance with claim 1, wherein the step of preparing the property for use by a second occupant comprises removing unwanted matter from the property.
